(19) United States
(12) Patent Application Publication
(10) Pub. No.: US 2022/0309766 A1
(43) Pub. Date: Sep. 29, 2022

(54) DEVICE AND METHOD FOR FORMING AT LEAST ONE GROUND TRUTH DATABASE FOR AN OBJECT RECOGNITION SYSTEM

(71) Applicant: BASF Coatings GmbH, Münster (DE)

(72) Inventors: Yunus Emre Kurtoglu, Southfield, MI (US); Matthew Ian Childers, Southfield, MI (US)

(21) Appl. No.: 17/616,792

(22) PCT Filed: Jun. 5, 2020
(86) PCT No.: PCT/EP2020/065747

§ 371 Date: Dec. 6, 2021

Related U.S. Application Data
(60) Provisional application No. 62/858,354, filed on Jun. 7, 2019.

(30) Foreign Application Priority Data
Jun. 7, 2019 (EP) 19179166.4

(51) Int. Cl. G06V 10/764; G06F 16/583; G06F 16/55

(52) U.S. Cl. CPC G06V 10/764; G06F 16/583; G06F 16/55

(57) ABSTRACT

Described herein are a device and a method for forming at least one ground truth database for an object recognition system and for keeping the at least one ground truth database current. The device comprises includes at least the following components: a data storage unit configured to store color space positions and/or reflectance spectra and/or luminescence spectra of different objects; and a processor programmed for communication with the data storage unit and with the object recognition system.

The present disclosure refers to a device and a method for forming at least one ground truth database for an object recognition system and for keeping the at least one ground truth database current.

### BACKGROUND

Computer vision is a field in rapid development due to abundant use of electronic devices capable of collecting information about their surroundings via sensors such as cameras, distance sensors such as LiDAR or radar, and depth camera systems based on structured light or stereo vision to name a few. These electronic devices provide raw image data to be processed by a computer processing unit and consequently develop an understanding of an environment or a scene using artificial intelligence and/or computer assistance algorithms. There are multiple ways how this understanding of the environment can be developed. In general, 2D or 3D images and/or maps are formed, and these images and/or maps are analyzed for developing an understanding of the scene and the objects in that scene. One prospect for improving computer vision is to measure the components of the chemical makeup of objects in the scene. While shape and appearance of objects in the environment acquired as 2D or 3D images can be used to develop an understanding of the environment, these techniques have some shortcomings.

One challenge in computer vision field is being able to identify as many objects as possible within each scene with high accuracy and low latency using a minimum amount of resources in sensors, computing capacity, light probe etc.

The object identification process has been termed remote sensing, object identification, classification, authentication or recognition over the years. In the scope of the present disclosure, the capability of a computer vision system to identify an object in a scene is termed as “object recognition”. For example, a computer analyzing a picture and identifying/labelling a ball in that picture, sometimes with even further information such as the type of a ball (basketball, soccer ball, baseball), brand, the context, etc. fall under the term “object recognition”.

Generally, techniques utilized for recognition of an object in computer vision systems can be classified as follows:

Technique 1: Physical tags (image based): Barcodes, QR codes, serial numbers, text, patterns, holograms etc.
Technique 2: Physical tags (scan/close contact based): Viewing angle dependent pigments, upconversion pigments, metachromics, colors (red/green), luminescent materials.
Technique 3: Electronic tags (passive): RFID tags, etc. Devices attached to objects of interest without power, not necessarily visible but can operate at other frequencies (radio for example).
Technique 4: Electronic tags (active): wireless communications, light, radio, vehicle to vehicle, vehicle to anything (X), etc. Powered devices on objects of interest that emit information in various forms.
Technique 5: Feature detection (image based): Image analysis and identification, i.e. two wheels at certain distance for a car from side view; two eyes, a nose and mouth (in that order) for face recognition etc. This relies on known geometries/shapes.
Technique 6: Deep learning/CNN based (image based): Training of a computer with many of pictures of labeled images of cars, faces etc. and the computer determining the features to detect and predicting if the objects of interest are present in new areas. Repeating of the training procedure for each class of object to be identified is required.
Technique 7: Object tracking methods: Organizing items in a scene in a particular order and labeling the ordered objects at the beginning. Thereafter following the object in the scene with known color/geometry/3D coordinates. If the object leaves the scene and re-enters, the “recognition” is lost.

In the following, some shortcomings of the above-mentioned techniques are presented.

Technique 1: When an object in the image is occluded or only a small portion of the object is in the view, the barcodes, logos etc. may not be readable. Furthermore, the barcodes etc. on flexible items may be distorted, limiting visibility. All sides of an object would have to carry large barcodes to be visible from a distance otherwise the object can only be recognized in close range and with the right orientation only. This could be a problem for example when a barcode on an object on the shelf at a store is to be scanned. When operating over a whole scene, technique 1 relies on ambient lighting that may vary.

Technique 2: Upconversion pigments have limitations in viewing distances because of the low level of emitted light due to their small quantum yields. They require strong light probes. They are usually opaque and large particles limiting options for coatings. Further complicating their use is the fact that compared to fluorescence and light reflection, the upconversion response is slower. While some applications take advantage of this unique response time depending on the compound used, this is only possible when the time of flight distance for that sensor/object system is known in advance. This is rarely the case in computer vision applications. For these reasons, anti-counterfeiting sensors have covered/dark sections for reading, class 1 or 2 lasers as probes and a fixed and limited distance to the object of interest for accuracy.

Similarly viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions.

Color-based recognitions are difficult because the measured color depends partly on the ambient lighting conditions. Therefore, there is a need for reference samples and/or controlled lighting conditions for each scene. Different sensors will also have different capabilities to distinguish different colors, and will differ from one sensor type/maker to another, necessitating calibration files for each sensor.

Luminescence based recognition under ambient lighting is a challenging task, as the reflective and luminescent components of the object are added together. Typically luminescence based recognition will instead utilize a dark measurement condition and a priori knowledge of the excitation region of the luminescent material so the correct light probe/source can be used.

Technique 3: Electronic tags such as RFID tags require the attachment of a circuit, power collector, and antenna to the item/object of interest, adding cost and complication to the design. RFID tags provide present or not type information but not precise location information unless many sensors over the scene are used.

Technique 4: These active methods require the object of interest to be connected to a power source, which is cost-prohibitive for simple items like a soccer ball, a shirt, or a box of pasta and are therefore not practical.

Technique 5: The prediction accuracy depends largely on the quality of the image and the position of the camera within the scene, as occlusions, different viewing angles, and the like can easily change the results. Logo type images can be present in multiple places within the scene (i.e., a logo can be on a ball, a T-shirt, a hat, or a coffee mug) and the object recognition is by inference. The visual parameters of the object must be converted to mathematical parameters at great effort. Flexible objects that can change their shape are problematic as each possible shape must be included in the database. There is always inherent ambiguity as similarly shaped objects may be misidentified as the object of interest.

Technique 6: The quality of the training data set determines the success of the method. For each object to be recognized/classified many training images are needed. The same occlusion and flexible object shape limitations as for Technique 5 apply. There is a need to train each class of material with thousands or more of images.

Technique 7: This technique works when the scene is pre-organized, but this is rarely practical. If the object of interest leaves the scene or is completely occluded the object could not be recognized unless combined with other techniques above.

A total number of classifications is dependent on the required accuracy determined by a respective end use case. While universal and generalized systems require capabilities to recognize a higher number of classes, it is possible to cluster objects to be recognized based on 3D location to minimize the number of classes available in each scene if the 3D locations can be dynamically updated with such class clusters without using the computer vision system itself but other dynamic databases that may keep track. Smart homes, computer vision enabled stores and manufacturing and similar controlled environments can provide such information beyond computer vision techniques to limit the needed number of classes.

Apart from the above-mentioned shortcomings of the already existing techniques, there are some other challenges worth mentioning. The ability to see a long distance, the ability to see small objects or the ability to see objects with enough detail all require high resolution imaging systems, i.e. high-resolution camera, LiDAR, radar etc. The high-resolution needs increase the associated sensor costs and increase the amount of data to be processed.

For applications that require instant responses like autonomous driving or security, the latency is another important aspect. The amount of data that needs to be processed determines if edge or cloud computing is appropriate for the application, the latter being only possible if data loads are small. When edge computing is used with heavy processing, the devices operating the systems get bulkier and limit ease of use and therefore implementation.

One challenge associated with using luminescent materials in recognition/authentication applications is the concerns over their degradation over time, especially of fluorescent materials. There are two potential outcomes fur such degradation: luminescence may diminish over time or shift in spectral space upon exposure to the environmental conditions such as ultraviolet radiation, moisture, pH and temperature changes, etc. While stabilization of such systems against such environmental conditions is possible with UV absorbers, antioxidants, encapsulation techniques, etc., there are limitations associated with each such approach.

Thus, a need exists for systems and methods that are suitable for improving object recognition capabilities for computer vision applications, particularly in view of the above mentioned shortcomings.

### SUMMARY OF THE INVENTION

Therefore, it was an object of the present disclosure to provide a device and a method for forming at least one ground truth database for an object recognition system and for keeping the at least one ground truth database current.

The present disclosure provides a device and a method with the features of the independent claims. Embodiments are subject of the dependent claims and the description and drawings.

Therefore, a device is provided for forming at least one ground truth database for an object recognition system and for keeping the at least one ground truth database current, the device comprising at least the following components:
a) at least one data storage unit configured to store color space positions/coordinates and/or reflectance spectra and/or luminescence spectra of different objects; and
b) a processor programmed for communication with the data storage unit, i. e. the processor is in a communicative connection with the data storage unit, and with the object recognition system, the processor programmed for:
   receiving, via a communication interface, color space positions/coordinates and/or reflectance spectra and/or luminescence spectra of different objects,
   assigning each received color space position and/or reflectance and/or luminescence spectrum to one of the different objects as a tag,
   storing the color space positions and/or reflectance and/or luminescence spectra together with the respective different objects the color space positions and/or reflectance and/or luminescence spectra are assigned to, respectively, in the at least one data storage unit, thus forming the at least one ground truth database,
   monitoring, by using at least one sensor and/or artificial intelligence tools, both being connected with or integrated in the processor, a scene which includes at least some of the different objects for the occurrence of a triggering event and/or a recognition event,
   updating and/or supplementing dynamically, if necessary, in at least one of the at least one ground truth database the color space positions and/or the reflectance and/or luminescence spectra stored in the respective at least one database in the case the triggering and/or recognition event occurs, and
   providing immediate access to the up-to-date color positions and/or reflectance spectra and/or luminescence spectra.

In the following, the terms “triggering event” and “triggering and/or recognition event” are used synonymously.

It is possible that the device further comprises a measuring device such as a spectrophotometer and/or a camera-based measuring device which is in communicative connection with the processor and configured to determine/measure the reflectance spectra and/or the luminescence spectra and/or the color space positions of the different objects. The camera can be a multispectral and/or a hyperspectral camera. The measuring device may be a component of the object recognition system.

For the monitoring step, the device may further comprise the at least one sensor, particularly at least one vision sensor, particularly a camera, and the artificial intelligence tools, both being in communicative connection with or integrated in the processor, thus enabling the processor to detect, by means of the sensor means, and to identify, by means of the artificial intelligence tools, the triggering event and/or the recognition event. The artificial intelligence tools are trained and configured to use input from the sensor means, i. e. the at least one sensor, such as cameras, microphones, wireless signals, to deduce the triggering and/or recognition event. Thus, the processor is configured to announce at least one object which is to be added to or deleted from at least one of the at least one ground truth database as a direct or indirect result of the triggering and/or recognition event. The artificial intelligence tools comprise or may have access to triggering events and/or recognition events or at least basic information about them which have been trained before and rules for conclusions. The artificial intelligence tools and/or the sensor means can be integrated in the processor. The artificial intelligence tools may be realized via an accordingly trained neural network.

Such triggering and/or recognition event may be newly measured and received respective color space positions/coordinates and/or reflectance spectra and/or luminescence spectra for at least some of the different objects located in the scene so that also small and continuous changes of the respective objects can be tracked in the respective at least one database. A further triggering event may be the occurrence of new objects visibly entering the scene with respective new color space coordinates and/or reflectance spectra and/or luminescence spectra. Such color space coordinates and/or reflectance spectra and/or luminescence spectra are to be determined, particularly measured and assigned to the respective objects. A further triggering event may be, for example, a merging of different data sets which have been received by the sensor means, by the artificial intelligence tools. Any other action which can be detected by the sensor means can be defined as a triggering event. Credit card transactions, receipts, emails, text messages received by a respective receiving unit which functions as sensor means, may also trigger/cause an updating of the at least one ground truth database, thus serving as respective triggering events. Unpacking of groceries in a kitchen enabled with the above mentioned sensor means, such as respectively equipped cameras would for example induce the processor to recognize the unpacking action as triggering event by using the above mentioned artificial intelligence tools. This would then be the triggering event to add the unpacked items to the at least one ground truth database. Throwing the items to the garbage or recycling bin would similarly trigger to remove them from the at least one ground truth database, thus serving as respective triggering event. Grocery store receipts/transactions can add the items (objects) purchased directly to the at least one ground truth database. Online order/confirmation email of a new household item could be a triggering event to add the item to the at least one ground truth database. A new item (object) that is visible entering through the door enabled with a camera (as sensor means) would induce the processor to recognize the entry and add the item to the at least one ground truth database. Similarly an item (object) exiting through the door would trigger to remove that item from the at least one ground truth database. When a shopping list item is added to the list on an AI (artificial intelligence) device such as a smart speaker, that item can be added to the at least one ground database, i. e. the addition of the shopping list item is the triggering event. The AI device functions as all-in-one device suitable for detecting and identifying a triggering and/or recognition event.

The proposed device provides at least one ground truth database for a surface chemistry/color-based object recognition system. The invention addresses issues relating to color fading or shifting in ground truth database formation for chemistry/color space-based object recognition systems in computer vision applications. It is proposed to utilize luminescent or color space-based object recognition techniques and specifically to manage the color space or reflective/luminescent spectra that are used as respective tags for objects of interest by specifically designing color space specifications to include not only the original color space position of each object and its standard deviation but also a degradation path and a surrounding space with the associated standard deviation. Furthermore, the proposed device describes how the computer vision system utilizing color/chemistry-based recognition techniques can be used to update the ground truth database dynamically to increase recognition performance.

It is further possible to include use of 3D location clusters of the objects of interest to improve the accuracy of object recognition predictions by continuously monitoring any shifts of color in recognition articles (objects) of interest.

Within the scope of the present disclosure the terms “fluorescent” and “luminescent” are used synonymously. The same applies to the terms “fluorescence” and “luminescence”.

According to one further embodiment, the proposed device comprises the processor programmed for providing as the at least one ground truth database a master database and a local database, the local database being in conjunction, i. e. in communicative connection with the master database. Further, the color space positions and/or the reflectance spectra and/or luminescence spectra stored in the local database are updated and/or supplemented over time by receiving from the object recognition system re-measured respective color space positions and/or reflectance spectra and/or luminescence spectra for the different objects in the scene and, thus, small and continuous changes of the respective objects are at least tracked in the local database.

Specifically, the local database is stored locally in the scene or on a cloud server, the local database being only accessible for the object recognition system which is locally used in the scene. The master database is accessible for all object recognition systems which have subscribed to use any of the ground truth databases formed by the proposed device, i.e. which have been authorized to use those databases by subscription.

According to one further embodiment the device comprises the processor programmed for tracking the small and continuous changes of the respective objects by monitoring changes in fluorescence emission magnitude and/or fluorescence emission spectral shapes of the respective objects.

The device further comprises the processor programmed for supplementing the local database by a color space position and/or a reflectance spectrum and/or luminescence spectrum of an object by using the master database when the object is new in the scene (newly entering the scene) and the new object's color space position and/or reflective and luminescence spectrum measured by the locally used object recognition system can be matched to a color space position and/or a reflectance spectrum and/or luminescence spectrum of an object stored in the master database.

The device further comprises the processor programmed for synchronizing the master database and the local database regarding the different objects in the scene within predefined time intervals or when one of a number of predefined events occurs. The master database can synchronize with the local database on a set interval, on a non-set interval when the master database is updated or improved, or when the local database experiences a triggering event such as an unrecognized object, new object purchase detection, etc.

Further triggering and/or recognition events for updating at least the local database are defined by “end of use” recognition events. The occurrence of such “end of use” recognition events lead to a prompt removal of the respective objects from the respective local database, increasing local database efficiency. Such “end of use” recognition events can be listed as recycling, disposal, consumption or other end of use definitions appropriate for the respective object to be recognized. Normally, an object with its assigned tag is only removed from the local database and stays in the master database. One reason to remove an object with its designed tag from the master database would be to remove the ability to recognize it for all users.

Further, to trigger a registry of objects to a respective local database, initiation recognition events are defined as respective triggering and/or recognition events for updating the respective local database accordingly when any of such initiation recognition events occurs. Such initiation recognition events can be listed as: unpacking, entry into the scene or field of view (of the sensor), check out event (leaving the scene), manufacturing quality control, color matching measurements, etc. For example, a user or another automated system may “initiate” an object by adding it to the local database when it is first acquired.

Similarly, the object may be “retired” by removing it from the local database when it is disposed of at the end of its useful life. Alternatively or additionally, another database can be formed to track the color positions of the objects that are discarded in a recycling bin, trash bin or other physical space that may be used in future tasks such as sorting/separation of recyclables and/or different types of waste for efficient processing.

According to a further embodiment of the invention, the master database comprises for each of the different objects color space position and/or reflectance spectrum and/or luminescence spectrum of the original object and color space position and/or reflectance spectrum and/or luminescence spectrum of at least one degraded/aged object descending from the original object.

An object can be imparted, i. e. provided with luminescent, particularly fluorescent materials in a variety of methods. Fluorescent materials may be dispersed in a coating that may be applied through methods such as spray coating, dip coating, coil coating, roll-to-roll coating, and others. The fluorescent material may be printed onto the object. The fluorescent material may be dispersed into the object and extruded, molded, or cast. Some materials and objects are naturally fluorescent and may be recognized with the proposed system and/or method. Some biological materials (vegetables, fruits, bacteria, tissue, proteins, etc.) may be genetically engineered to be fluorescent. Some objects may be made fluorescent by the addition of fluorescent proteins in any of the ways mentioned herein. The color positions and/or the reflectance and fluorescence spectra of different objects may be measured by at least one camera and/or at least one spectrophotometer or a combination thereof, and provided to the processor for forming the at least one ground truth database.

Many fluorescent and reflective materials degrade over time with exposure to light (particularly ultraviolet light) or oxygen. Most of these materials have their fluorescence emission reduced in magnitude, but some may undergo changes in their fluorescence emission spectral shapes, i.e. in their fluorescence spectra.

In the first case, beyond the difficulty of measuring lower amounts of fluorescence emission amounts, difficulties of matching a known fluorescence spectrum in a database may occur if multiple fluorescent materials with different degradation rates are present in the scene. In the second case, the problem of matching a changed fluorescence spectrum to a database of original spectra is obvious. Therefore, it is proposed that the master database comprises for each original object at least color space position and/or reflectance spectrum and/or luminescence spectrum of at least one degraded/aged object descending from the original object.

The invention proposes to include a local database in conjunction (in communicative connection) with a master database. A new object in the scene would initially be classified with the master database on the assumption that the object has a non-degraded spectrum. Once detected, the object can be included in the local database for quicker identification in the future. Additionally, the spectra of the object measured by the object recognition system can be updated over time, so that small and continuous changes of the object are tracked in the local database. At the end of an object's useful life (end of use recognition event), it may be identified correctly by the local database despite its current emission spectra better matching (in the meantime) another object's original emission spectra in the master database.

An object need not always be in view of the sensor. For example, the sensor may be located in a kitchen pantry where an object is first identified. The object may be removed for a period of time (i.e. dinner preparation) and then replaced. The object would not be removed from the local database while it was out of view of the sensor, so it would still be recognized when returned. It will only be removed from the local database when it is absent from the scene (out of view of the sensor) for a predefined period of time. Such period of time can be defined with respect to normal habits.

It is to be stated that the local database need not be stored locally, it may still be cloud based, but only the local scene, i. e. the object recognition system locally used, will have access to it. There may be multiple local databases in various locations/areas and these local databases may overlap in some cases.

As mentioned above, another possible embodiment of the proposed device is for the master database to include aged/included samples of respective objects. The master database will first match to the original samples of the respective objects. However, over time, the master database will make comparisons to the aged/degraded samples that are the approximate age of the observed objects. Therefore, an exchange between the local database and the master database is necessary.

Each communicative connection between any of above mentioned components, such as between the processor and the data storage unit, between the processor and the object recognition system, between the processor and the measuring device, between the processor and the sensor means and between the local database and the master database, may be a wired or a wireless connection. Each suitable communication technology may be used. The respective component, such as the local database and the master database, each may include one or more communication interface for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

To realize such matching algorithm between a spectrum observed in a scene and a spectrum in the local database and/or the master database, confidence threshold and error thresholds are required. For example, a match between a spectrum observed in a scene and a spectrum in the local database and/or in the master database must meet the confidence threshold to enable an identification of the object associated with the measured spectrum. However, there may still be some error between the measured/observed spectrum and the assigned/stored spectrum for one and the same object. If this error is greater than the error threshold, then the spectra in the local database and/or in the master database may need to be updated.

Other improvements may also be added to the device by asking a user to select from possible object recognitions/identifications (either in the local database and/or in the master database) via a user interface coupled with the processor. The user interface may be realized by an input and output device, e.g. a graphical user interface or an acoustic interface. There may be a display for displaying the respective inquiries. Alternatively, a loudspeaker could output any selection from which a user is asked to select one or more of the possible identifications. The respective user input can be realized via a GUI and/or a microphone. The user feedback is used to improve the accuracy of future identifications within the databases, particularly within the local database. Alternatively, the device may ask via the user interface the user if a specific chosen identification is correct and use the feedback to improve future identifications with the local database.

The disclosure further refers to a computer-implemented method for forming at least one ground truth database for an object recognition system and for keeping the at least one ground truth database current, the method comprising at least the following steps:
providing via a communications interface color space positions/coordinates and/or reflectance spectra and/or luminescence spectra of different objects, e.g. by means of at least one spectrophotometer,
assigning, by a processor, each color space position and/or reflectance spectrum and/or luminescence spectrum to one of the different objects as a tag,
storing, by the processor, the color space positions and/or reflectance spectra and/or luminescence spectra together with the respective different objects the color space positions and/or reflectance spectra and/or luminescence spectra are assigned to, respectively, in a data storage unit, thus forming the at least one ground truth database,
monitoring, by using at least one sensor and/or artificial intelligence tools, both being in communicative connection with the processor, a scene which includes at least some of the different objects for the occurrence of a triggering and/or recognition event,
updating and/or supplementing, by the processor, dynamically, if necessary, in at least one of the at least one database the color space positions and/or the reflectance spectra and/or luminescence spectra stored in the at least one database in the case the triggering and/or recognition event occurs, thus, tracking small and continuous changes of the respective objects in the at least one of the at least one database, and
providing immediate access to the up-to-date color positions and/or reflectance spectra and/or luminescence spectra.

The proposed method may further comprise the step of measuring the color space positions/coordinates and/or reflectance spectra and/or luminescence spectra of different objects by means of at least one spectrophotometer. The at least one spectrophotometer may be a component of the object recognition system. Further the proposed method may comprise the step of providing the different objects with fluorescent materials, respectively.

The triggering and/or recognition event may be realized by one or more new objects visibly entering the scene and/or by changed respective color space positions and/or spectra for one or more of the different objects located in the scene which have been re-measured by the object recognition system.

For the monitoring step, sensor means, particularly a camera, and artificial intelligence tools may be provided, both, the sensor means and the artificial intelligence tools are in communicative connection with or integrated in the processor, thus enabling the processor to detect, by means of the sensor means, and to identify, by means of respective artificial intelligence tools, the triggering event. The artificial intelligence tools are trained and configured to use input from the sensor means, such as cameras, microphones, wireless signals, to deduce the triggering and/or recognition event. Thus, the processor is configured to announce at least one object which is to be added to or deleted from at least one of the at least one ground truth database as a direct or indirect result of the triggering and/or recognition event. The artificial intelligence tools comprise or may have access to triggering and/or recognition events or at least basic information about them which have been trained before and rules for conclusions. The artificial intelligence tools and/or the sensor means can be integrated in the processor. The artificial intelligence tools may be realized via an accordingly trained neural network.

According to an embodiment of the proposed method, the method further comprises providing as the at least one ground truth database a master database and a local database, the local database being in conjunction (in communicative connection) with the master database. The color space positions and/or the reflectance spectra and/or luminescence spectra stored in the local database are updated and/or supplemented over time by re-measuring, by the object recognition system, the respective color space positions and/or the reflectance spectra and/or luminescence spectra for the different objects in the scene or by monitoring the scene for new objects entering the scene or by recognizing the occurrence of a further triggering and/or recognition event, and, thus, small and continuous changes in the scene are at least tracked in the local database.

The local database may be stored locally in the scene or on a cloud server, the local database being only accessible for the object recognition system which is locally used in the scene.

According to a further embodiment of the proposed method, the small and continuous changes of the respective objects are tracked by monitoring changes in fluorescence emission magnitude/amplitude and/or fluorescence emission spectral shape of the fluorescence spectrum of the respective objects.

The local database may be supplemented by a color space position and/or a reflectance spectrum and/or luminescence spectrum of an object by using the master database when the object is new in the scene and the new object's color space position and/or reflectance spectrum and/or luminescence spectrum measured by the locally used object recognition system can be matched to a color space position and/or a reflectance spectrum and/or luminescence spectrum of an object stored in the master database.

The master database and the local database are synchronized regarding the different objects in the scene within predefined time intervals or when at least one of a number of predefined events occurs. Such time intervals for updates can be hours, days, weeks or months depending on the object.

The master database comprises for each of the different objects color space position and/or reflectance spectrum and/or luminescence spectrum of the original object and color space position and/or reflectance spectrum and/or luminescence spectrum of at least one degraded/aged object descending from the original object.

The present disclosure further refers to a non-transitory computer-readable medium storing instructions that, when executed by one or more processors, cause a machine to:
receive, via a communication interface, color space positions/coordinates and/or reflectance spectra and/or luminescence spectra of different objects,
assign each color space position and/or reflectance spectrum and/or luminescence spectrum to one of the different objects as a tag,
store the color space positions and/or reflectance spectra and/or luminescence spectra together with the respective different objects the color space positions and/or reflectance spectra and/or luminescence spectra are assigned to, respectively, in a data storage unit, thus forming at least one ground truth database,
monitor, by using at least one sensor and/or artificial intelligence tools, a scene which includes at least some of the different objects for the occurrence of a triggering and/or recognition event,
update and/or supplement dynamically, if necessary, in at least one of the at least one database the color space positions and/or the reflectance spectra and/or luminescence spectra stored in the at least one database in the case the triggering and/or recognition event occurs, thus, tracking small and continuous changes in the scene in the at least one of the at least one database, and
provide immediate access to the up-to-date color positions and/or reflectance spectra and/or luminescence spectra.

Such triggering and/or recognition event can be given by new objects visibly entering the scene and/or by receiving respective re-measured color positions and/or spectra for the different objects located in the scene.

Further, a respective computer program product having instructions that are executable by one or more processors, is provided, the instructions cause a machine to perform the above mentioned method steps.

The processor may include or may be in communication, i. e. in communicative connection with one or more input units, such as a touch screen, an audio input, a movement input, a mouse, a keypad input and/or the like. Further the processor may include or may be in communication with one or more output units, such as an audio output, a video output, screen/display output, and/or the like.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the data processing unit/processor described herein and related components may be a portion of a local computer system or a remote computer or an online system or a combination thereof. The database, i.e. the data storage unit and software described herein may be stored in computer internal memory or in a non-transitory computer readable medium.

The invention is further defined in the following examples. It should be understood that these examples, by indicating preferred embodiments of the invention, are given by way of illustration only. From the above discussion and the examples, one skilled in the art can ascertain the essential characteristics of this invention and without departing from the spirit and scope thereof, can make various changes and modifications of the invention to adapt it to various uses and conditions.

### BRIEF DESCRIPTION OF THE DRAWINGS

FIG. 1 shows schematically a flowchart of method for object recognition using at least one ground truth database formed and updated using one embodiment of the proposed device and/or of the proposed method.

FIG. 2 shows schematically a flowchart of instructions of an embodiment of the proposed computer-readable medium.

### DETAILED DESCRIPTION OF THE DRAWINGS

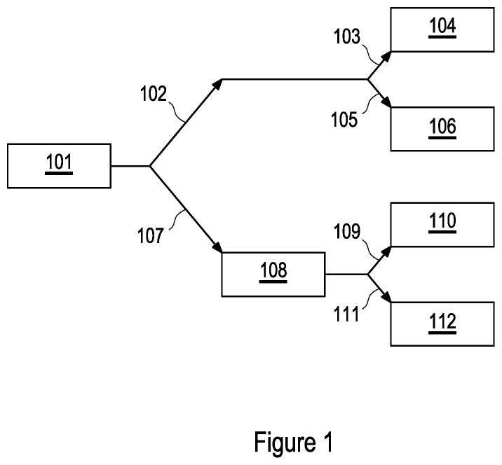

FIG. 1 shows schematically a flow chart of a method for recognizing via an object recognition system, an object in a scene using a ground truth database which is formed and kept current using an embodiment of the method proposed by the present disclosure.

In the example described here, an object recognition system is provided which is used to recognize objects in a scene by sensing/measuring via a sensor, e. g. a spectrophotometer, reflectance spectra and/or luminescence spectra of the objects present in the scene and identifying by means of a measured fluorescence spectrum a specific object whose specific fluorescence spectrum is stored as a tag in a respective ground truth database which can be accessed by the object recognition system.

The object recognition system which is used to recognize objects in the scene has access at least to a local database stored in a data storage unit, the local database storing fluorescence spectra of objects which are or have been located locally in the respective scene. Besides such a local database, the data storage unit can also host a master database which is communicatively connected with the local database but which stores the fluorescence spectra of more than only the locally measured objects. Therefore, the master database is accessible for more than only the object recognition system which is locally used to recognize objects locally in the scene. The master database can also be stored in a further data storage unit which is in a communicative connection with the data storage unit storing the local database.

The data storage unit storing the local database as well as the data storage unit storing the master database can be realized by single standing-alone servers and/or by a cloud server. Both, the local database as well as the master database can be stored on a cloud.

The proposed device for forming the local database and also the master database for the object recognition system and for keeping the local database and the master database current, comprises besides the already mentioned at least one data storage unit, a processor which is programmed for a communication with the data storage unit and with the object recognition system. The processor is programmed for:
receiving, via a communication interface, color space positions/coordinates and/or reflectance spectra and/or luminescence spectra of different objects,
assigning each color space position and/or reflectance spectrum and/or luminescence spectrum to one of the different objects as a tag,
storing the color space positions and/or reflectance spectra and/or luminescence spectra together with the respective different objects the color space positions and/or reflectance spectra and/or luminescence spectra are assigned to, respectively, in the data storage unit, thus forming at least one ground truth database, namely the local database and/or the master database,
monitoring, by using at least one sensor and/or artificial intelligence tools, a scene which includes at least some of the different objects for the occurrence of a triggering and/or recognition event,
updating and/or supplementing dynamically in at least one of the local database and the master database the color space positions and/or the reflectance spectra and/or luminescence spectra by continuously monitoring the scene for the occurrence of a triggering and/or recognition event and, thus, tracking small and continuous changes in the scene in the respective database.

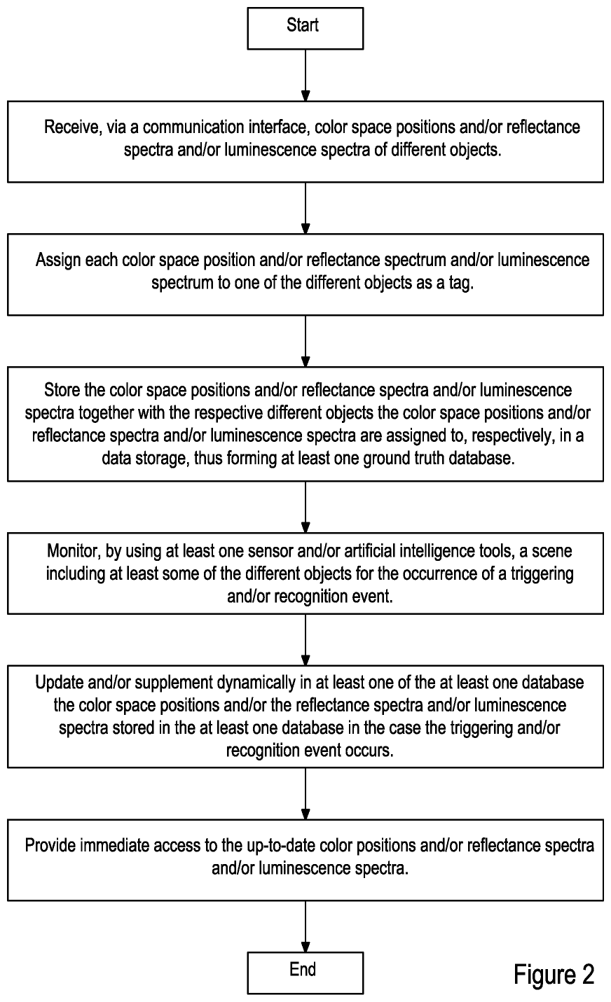

Such method steps can be executed by the processor when an embodiment of the proposed non-transitory computer-readable medium is used/loaded which comprises the instructions as shown in FIG. 2.

A triggering and/or recognition event can be a new object entering the scene and, thus, provoking/initiating the measuring of a new reflectance spectrum and/or luminescence spectrum within the scene. A further triggering and/or recognition event can be given by receiving newly measured color space positions and/or reflectance spectra and/or luminescence spectra of the objects which have already been present in the scene but which have degraded over time.

In a step 101 a reflectance spectrum and a fluorescence spectrum are sensed/measured by an object recognition system used locally for recognizing objects in a scene. The object recognition system provides, for example, a specific fluorescence spectrum for an object which is to be recognized/identified. Therefore, the local database storing the fluorescence spectra of all objects which have up to now been identified in the scene, is searched for a matching fluorescence spectrum. In the case a match is found in a method step 102, it is further examined whether the spectrum found in the local database needs to be updated because the identified fluorescence spectrum deviates from the stored fluorescence spectrum, but still meets a confidence threshold to enable an identification on the basis of the measured fluorescence spectrum. Generally, to implement the local database, confidence thresholds and error thresholds are required. For example, a match between a fluorescence spectrum observed in the scene and a fluorescence spectrum in the local database must meet the confidence threshold to enable an identification. However, there may still be some error between the observed and assigned fluorescence spectrum. If this error is greater than the error threshold as indicated by arrow 103, then the stored fluorescence spectrum in the local database is updated in step 104. If it is stated in step 105 that the observed fluorescence spectrum and the fluorescence spectrum stored in the local database meet the error threshold, the object is identified in a step 106 without updating the local database. If there is no matching result found in the local database for the measured fluorescence spectrum, in a step 107, the master database is searched in step 108 for a fluorescence spectrum matching the sensed/measured fluorescence spectrum. If a match is found in the master database in step 109, the object can be identified in a step 110 and the matching fluorescence spectrum of the identified object is added together with its assigned object to the local database, indicating that the respective object is currently located in the scene and, thus, the local database which can be assigned to the respective scene is updated accordingly. If no match can be found in a step 111 in the master database, it is to be stated in step 112 that no match can be detected and no object can be recognized.

It is further possible to output via an output unit, such as a display, a selection of possible objects and to ask a user to select via a user interface, such as a touch screen, from such selection of possible object identifications, either in the local database or in the master database, and to use the user feedback to improve an accuracy of future identifications within the local database. That means that the objection recognition system can also be trained dynamically by the user feedback, thus improving the prediction dynamically. It is also possible to ask the user via a communication interface if an identification is correct and to use the feedback to improve future identifications within the local database. Additionally, if no match can be found neither in the local database nor in the master database, the object has to be identified manually by a user and its newly measured fluorescence spectrum can then be stored together with the respective object in both, the local database and the master database. Not only a user but also another automated system can “initiate” such an object by adding it to the local database when it is first acquired. Similarly, an object may be “retired” by removing it from the local database (and also from the master database if needed) when it is disposed of at the end of its useful life.

The object recognition procedure has been described using the example of a fluorescence spectrum of a specific object, the same procedure can be performed using a reflectance spectrum and/or color coordinates of the object to be recognized providing that the respective ground truth databases comprise reflectance spectra and/or color coordinates of objects.

Generally, an object recognition system can operate by using distinctive fluorescence emission and reflective spectrums as a method of object identification. This necessitates having a database of known or measured fluorescence spectra and/or reflectance spectra that the unknown object is compared to and selecting a best match from the respective database. The present disclosure considers that many fluorescent and/or reflective materials used for object recognition degrade over time with exposure to light or oxygen. Most of these materials have their fluorescence emission reduced in magnitude, but some may undergo changes in their fluorescence emission spectral shapes, i.e. in their fluorescence spectra. The present disclosure proposes now to include a local database in conjunction with a master database. A new object entering a scene would initially be classified with the master database on the assumption that the object has a non-degraded reflectance spectrum and/or luminescence spectrum. Once detected, the object can be included in the local database for quicker identification in the future. The local database is only accessible by the object recognition system locally used in the respective scene. Additionally, the fluorescence spectra and the reflectance spectra of the object measured by the object recognition system can be updated over time, so that small and continuous changes of the object are tracked in the local database. At the end of an object's useful life, it may be identified correctly by the local database despite its current emission spectra better matching another object's original emission spectra in the master database. Confidence thresholds and error thresholds are defined. The match between a spectrum observed in the scene and the spectrum in the local database must meet the confidence threshold to enable an identification. However, due to the possible degradation of the underlying fluorescent and reflective material over time, there may still be some error between the observed and assigned reflectance spectrum and/or fluorescence spectrum. If this error is greater than the error threshold, then the respective spectrum of the object in the local database may need to be updated, thus checking continuously small changes of the object in the local database. This makes it possible to identify an object although it's fluorescent and/or reflective material has changed over time. If no match can be found, it is possible to provide a user via a communication interface with a selection of possible object identifications either in the local database or master database whose spectra are beyond the confidence threshold but still within a possible identification area and to ask the user to select from such provided selection and to use such user feedback to improve the accuracy of future identifications within the local database. Alternatively, the user can also be asked if an identification is correct and to use such feedback also to improve future identifications within the local database. For initiating such a user interaction the proposed device provides a user interface, i. e. a communication interface for that the user can make some inputs. Such user interface is directly connected with the processor and via the processor also with the respective databases. The user interface can also be realized by a standing-alone computing device providing the input device for a user. All suitable known technologies are possible.

1. A device for forming at least one ground truth database for an object recognition system and for keeping the at least one ground truth database current, the device comprising at least the following components:
a) a data storage unit configured to store color space positions and/or reflectance spectra and/or luminescence spectra of different objects; and
b) a processor programmed for communication with the data storage unit and with the object recognition system, the processor programmed for:
receiving, via a communication interface, measured color space positions and/or reflectance spectra and/or luminescence spectra of different objects,
assigning each color space position and/or reflectance spectrum and/or luminescence spectrum to one of the different objects as a tag,
storing the color space positions and/or reflectance spectra and/or luminescence spectra together with the respective different objects the color space positions and/or reflectance spectra and/or luminescence spectra are assigned to, respectively, in the data storage unit, thus forming the at least one ground truth database,
monitoring, by using at least one sensor and/or artificial intelligence tools, a scene including at least some of the different objects for the occurrence of a triggering and/or recognition event,
updating and/or supplementing dynamically in at least one of the at least one database the color space positions and/or the reflectance spectra and/or luminescence spectra stored in the respective at least one database in the case the triggering and/or recognition event occurs, and
providing immediate access to the up-to-date color space positions and/or reflectance spectra and/or luminescence spectra.

2. The device according to claim 1, further comprising the processor programmed for providing as the at least one ground truth database a master database and a local database, the local database being in conjunction with the master database and the color space positions and/or the reflectance spectra and/or luminescence spectra stored in the local database are updated and/or supplemented over time by receiving from the object recognition system re-measured respective color space positions and/or reflectance spectra and/or luminescence spectra for at least some of the different objects in the scene and, thus, small and continuous changes of the respective objects are at least tracked in the local database.

3. The device according to claim 2, wherein the local database is stored locally in the scene or on a cloud server, the local database being only accessible for the object recognition system which is locally used in the scene.

4. The device according to claim 1, further comprising the processor programmed for tracking small and continuous changes of the different objects by monitoring changes in fluorescence emission magnitude and/or fluorescence emission spectral shapes of the respective objects.

5. The device according to claim 2, further comprising the processor programmed for supplementing the local database by a color space position and/or a reflectance spectrum and/or luminescence spectrum of an object by using the master database when the object is new in the scene and the new object's color space position and/or reflective and luminescence spectrum measured by the locally used object recognition system can be matched to a color space position and/or a reflectance spectrum and/or luminescence spectrum of an object stored in the master database.

6. The device according to claim 2, further comprising the processor programmed for synchronizing the master database and the local database regarding the different objects in the scene.

7. The device according to claim 2, wherein the master database comprises for each of the different objects color space position and/or reflectance spectrum and/or luminescence spectrum of the original object and color space position and/or reflectance spectrum and/or luminescence spectrum of at least one degraded/aged object descending from the original object.

8. A computer-implemented method for forming at least one ground truth database for an object recognition system and for keeping the at least one ground truth database current, the method comprising at least the following steps:
providing, via a communication interface, color space positions and/or reflectance spectra and/or luminescence spectra of different objects,
assigning, by a processor, each color space position and/or reflectance spectrum and/or luminescence spectrum to one of the different objects as a tag,
storing the color space positions and/or reflectance spectra and/or luminescence spectra together with the respective different objects the color space positions and/or reflectance spectra and/or luminescence spectra are assigned to, respectively, in a data storage, thus forming the at least one ground truth database,
monitoring, by using at least one sensor and/or artificial intelligence tools, a scene including at least some of the different objects for the occurrence of a triggering and/or recognition event,
updating and/or supplementing dynamically in at least one of the at least one database the color space positions and/or the reflectance spectra and/or luminescence spectra stored in the at least one database in the case the triggering and/or recognition event occurs, and
providing immediate access to the up-to-date color positions and/or reflectance spectra and/or luminescence spectra.

9. The method according to claim 8, further comprising providing a master database and a local database, the local database being in conjunction with the master database and the color space positions and/or the reflectance spectra and/or luminescence spectra stored in the local database are updated and/or supplemented over time by re-measuring by the object recognition system the respective color space positions and/or reflectance spectra and/or luminescence spectra for the different objects and, thus, small and continuous changes of the respective objects are at least tracked in the local database.

10. The method according to claim 9, wherein the local database is stored locally in the scene or on a cloud server, the local database being only accessible for the object recognition system which is locally used in the scene.

11. The method according to claim 8, wherein small and continuous changes of the different objects are tracked by monitoring changes in fluorescence emission magnitude and/or fluorescence emission spectral shapes of the respective objects.

12. The method according to claim 9, wherein the local database is supplemented by a color space position and/or a reflectance spectrum and/or luminescence spectrum of an object by using the master database when the object is new in the scene and the new object's color space position and/or reflectance spectrum and/or luminescence spectrum measured by the locally used object recognition system can be matched to a color space position and/or a reflectance spectrum and/or luminescence spectrum of an object stored in the master database.

13. The method according to claim 9, wherein the master database and the local database are synchronized regarding the different objects in the scene when at least one of a number of predefined events occurs.

14. The method according to claim 13, wherein the master database comprises for each of the different objects a color space position and/or a reflectance spectrum and/or luminescence spectrum of the original object and a color space position and/or a reflectance spectrum and/or luminescence spectrum of at least one degraded/aged object descending from the original object.

15. A non-transitory computer-readable medium storing instructions that, when executed by one or more processors, cause a machine to:
receive, via a communication interface, color space positions and/or reflectance spectra and/or luminescence spectra of different objects,
assign each color space position and/or reflectance spectrum and/or luminescence spectrum to one of the different objects as a tag,
store the color space positions and/or reflectance spectra and/or luminescence spectra together with the respective different objects the color space positions and/or reflectance spectra and/or luminescence spectra are assigned to, respectively, in a data storage, thus forming at least one ground truth database,
monitor, using at least one sensor and/or artificial intelligence tools, a scene which includes at least some of the different objects for the occurrence of a triggering and/or recognition event,
update and/or supplement dynamically in at least one of the at least one database the color space positions and/or the reflectance spectra and/or luminescence spectra stored in the at least one database in the case the triggering and/or recognition event occurs, and
provide immediate access to the up-to-date color positions and/or reflectance spectra and/or luminescence spectra.
